(19) United States
(12) Patent Application Publication
(10) Pub. No.: US 2024/0376933 A1
(43) Pub. Date: Nov. 14, 2024

(54) TRANSMISSION SHAFT AND BEARING DEVICE USING SAME

(71) Applicant: NTN CORPORATION, Osaka-shi, Osaka (JP)

(72) Inventors: Naoki NAKATOCHI, Kuwana-shi, Mie (JP); Keisuke MIYAZAKI, Kuwana-shi, Mie (JP)

(21) Appl. No.: 18/684,624

(22) PCT Filed: Aug. 8, 2022
(86) PCT No.: PCT/JP2022/030282

§ 371 Date: Feb. 16, 2024

(30) Foreign Application Priority Data
Aug. 19, 2021 (JP) 2021-133926

(51) Int. Cl. F16C 33/62; F16C 19/44

(52) U.S. Cl. CPC F16C 33/62; F16C 19/44; F16C 2204/70

(57) ABSTRACT

This transmission shaft is used in a transmission and has a raceway surface on which needle rollers roll. The transmission shaft includes a base material and a triiron tetraoxide film. The base material includes any one of chromium steel, chromium-molybdenum steel, or nickel-chromium-molybdenum steel, and has, on a surface thereof, a diffusion layer including crystal grains of at least one of iron carbide, iron nitride, or iron carbonitride. The triiron tetraoxide film is formed on the surface of the base material and is disposed at least on the raceway surface.

### TECHNICAL FIELD

The present invention relates to a transmission shaft and a bearing device using the same.

### BACKGROUND ART

In a transmission such as a transmission, a bearing device that is a set of a shaft having an outer diameter portion serving as a raceway surface and a needle roller bearing with a cage disposed on an outer peripheral portion of the shaft is used. This bearing device is used under an environment with high temperature and with abundant foreign objects such as wear debris present. The bearing device is therefore required to be resistant to surface damage caused by foreign objects or poor lubrication. In particular, the shaft is a fixed component and has a structure in which the same portion is constantly prone to damage, so that the shaft tends to be the weakest portion.

As a method for extending the service life of a bearing under an environment with foreign objects present or under lean lubrication, an enhancing method in which a component including a steel material is subjected to heat treatment (carbonitriding treatment) in a carbonitriding atmosphere containing ammonia (NH₃) to increase the amount of retained austenite and the concentrations of carbon and nitrogen on the surface.

Further, for example, Japanese Patent Laying-Open No. 2006-161887 (PTL 1) discloses a technique to form indentations on a shaft or a roller by means of shot peening and cover the indentations with a solid lubricant to reduce the coefficient of friction. Similarly, for example, Japanese Patent Laying-Open No. 2017-106534 (PTL 2) discloses a technique to form a hardened layer (greater than or equal to Hv850 and less than or equal to Hv10000) on a surface layer by means of shot peening and apply large compressive residual stress (greater than or equal to 600 MPa and less than or equal to 1700 MPa in absolute value) for hardening.

### CITATION LIST

### Patent Literature

PTL 1: Japanese Patent Laying-Open No. 2006-161887
PTL 2: Japanese Patent Laying-Open No. 2017-106534

### SUMMARY OF INVENTION

### Technical Problem

It is, however, difficult to make the service life long enough only by general carbonitriding treatment. Further, the method for extending the service life using shot peening as in PTL 1 and 2 requires treatment unique to each product, which makes a manufacturing process complicated.

The present invention has been made to solve the above-described problems, and it is therefore an object of the present invention to provide a transmission shaft whose service life can be extended with a simple manufacturing process and a bearing device using the same.

### Solution to Problem

A transmission shaft of the present invention is used in a transmission and has a raceway surface on which needle rollers roll. The transmission shaft includes a base material and a triiron tetraoxide film. The base material includes any one of chromium steel, chromium-molybdenum steel, or nickel-chromium-molybdenum steel, and has, on a surface thereof, a diffusion layer including crystal grains of at least one of iron carbide, iron nitride, or iron carbonitride. The triiron tetraoxide film is formed on the surface of the base material and is disposed at least on the raceway surface.

Note that the transmission in the present invention may be either a speed reducer or a speed increaser.

In the transmission shaft, the triiron tetraoxide film has a thickness of greater than or equal to 1 μm and less than or equal to 2 μm.

In the transmission shaft, the base material includes chromium-molybdenum steel.

In the transmission shaft, an average grain size of prior austenite crystal grains in the surface of the base material is less than or equal to 8 μm.

In the transmission shaft, a proportion of an area of compound grains including the crystal grains of at least one of iron carbide, iron nitride, or iron carbonitride in the diffusion layer is greater than or equal to 3%, and an average grain size of the compound grains is less than or equal to 0.3 μm.

In the transmission shaft, the diffusion layer includes a plurality of martensite blocks.

In the transmission shaft, a largest grain size of the martensite blocks is less than or equal to 3.8 μm.

A bearing device of the present invention includes the transmission shaft and a plurality of needle rollers that roll on the raceway surface of the transmission shaft.

A method for manufacturing a transmission shaft of the present invention is a method for manufacturing a transmission shaft that is used in a transmission and has a raceway surface on which needle rollers roll, the method including the following processes.

A steel material including any one of chromium steel, chromium-molybdenum steel, or nickel-chromium-molybdenum steel is prepared. The steel material is subjected to carbonitriding. A triiron tetraoxide film is formed on a surface of the steel material subjected to carbonitriding.

In the method for manufacturing a transmission shaft, the steel material includes chromium-molybdenum steel. The process of subjecting the steel material to carbonitriding includes a process of heating the steel material to greater than or equal to 930° C. and less than or equal to 940° C. in a carbonitriding atmosphere containing ammonia. The steel material subjected to carbonitriding is heated to a primary quenching temperature of greater than 850° C. and less than 930° C., and then cooled to a temperature less than or equal to the Ms point, thereby subjecting the steel material to primary quenching. The steel material subjected to primary quenching is heated to a secondary quenching temperature of greater than or equal to the A1 point and less than 850° C., and then cooled to a temperature of less than or equal to the Ms point, thereby subjecting the steel material to secondary quenching.

### Advantageous Effects of Invention

According to the present invention, it is possible to provide the transmission shaft whose service life can be extended with a simple manufacturing process and the bearing device using the same.

### BRIEF DESCRIPTION OF DRAWINGS

FIG. 1 is a partially cutaway perspective view of a planetary gear and a support structure of the planetary gear in a planetary transmission with the planetary cut away.

FIG. 2 is a cross-sectional view of the planetary gear and the support structure of the planetary gear illustrated in FIG. 1.

FIG. 3 is an enlarged cross-sectional view of a structure of a transmission shaft in a region R illustrated in FIG. 2.

FIG. 4 is a flowchart illustrating a method for manufacturing the transmission shaft according to an embodiment.

FIG. 5 is a flowchart illustrating a detailed process of carbonitriding heat treatment illustrated in FIG. 4.

FIG. 6 is a graph showing a heat pattern under the method for manufacturing the transmission shaft according to the embodiment.

FIG. 7 is a diagram illustrating a driving force of a needle roller and a load distribution applied to a raceway surface in each of a state (A) where the raceway surface is straight and a state (B) where the raceway surface is bent.

FIG. 8 is a graph showing a result of measuring a carbon concentration and a nitrogen concentration for a sample 1 using an EPMA.

FIG. 9 is a graph showing a result of measuring a carbon concentration and a nitrogen concentration for a sample 2 using the EPMA.

FIG. 10 is an electron microscopy image of an area near a surface of sample 1.

FIG. 11 is an electron microscopy image of an area near a surface of sample 2.

FIG. 12 is an optical microscopy image of the area near the surface of sample 1.

FIG. 13 is an optical microscopy image of the area near the surface of sample 2.

FIG. 14 is a graph showing an average grain size of martensite blocks belonging to a third group and an average grain size of martensite blocks belonging to a fifth group, the martensite blocks being present in the area near the surface of each of samples 1 and 2.

FIG. 15 is a graph showing an average aspect ratio of martensite blocks belonging to the third group and an average aspect ratio of martensite blocks belonging to the fifth group, the martensite blocks being present in the area near the surface of each of samples 1 and 2.

### DESCRIPTION OF EMBODIMENTS

With reference to the drawings, an embodiment according to the present invention will be described below. Note that, in the following drawings, the same or corresponding parts are denoted by the same reference numerals to avoid the description from being redundant.

### <Planetary Gear and Support Structure of Planetary Gear in Planetary Transmission>

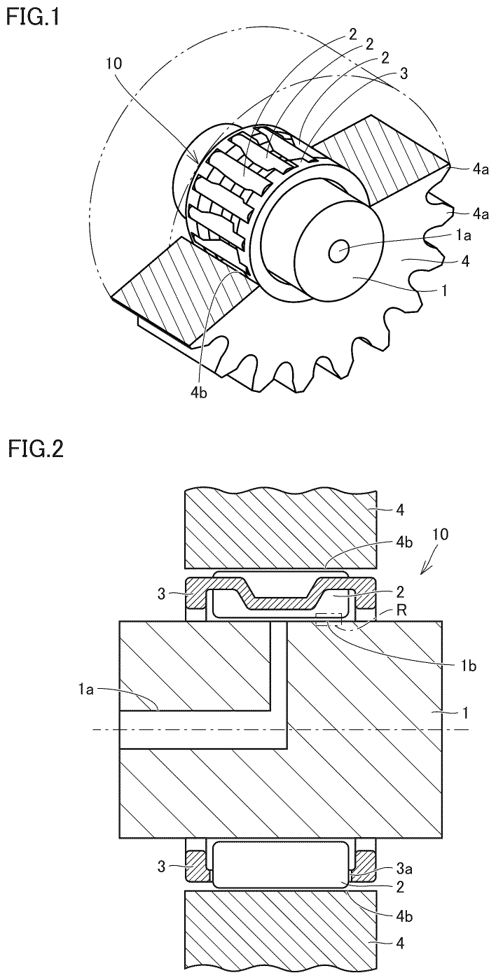

First, a planetary gear and a support structure of the planetary gear in a planetary transmission according to the embodiment will be described with reference to FIGS. 1 and 2.

FIG. 1 is a partially cutaway perspective view illustrating the planetary gear and the support structure of the planetary gear in the planetary transmission with the planetary gear cut away. FIG. 2 is a cross-sectional view of the planetary gear and the support structure of the planetary gear illustrated in FIG. 1.

The planetary transmission includes a planetary gear device. The planetary gear device includes three gear systems of a sun gear, a planetary gear, and an internal gear. In the planetary gear device, in response to input to one gear system, required gear change is performed by fixing or releasing one of the other two gear systems.

As illustrated in FIG. 1, a planetary gear 4 has a plurality of teeth 4a on its outer peripheral portion. Teeth 4a of planetary gear 4 mesh with teeth provided on an outer peripheral side of the sun gear (not illustrated). This causes planetary gear 4 to rotate along the outer peripheral side of the sun gear. Teeth 4a of planetary gear 4 further mesh with teeth provided on an inner peripheral side of the internal gear (not illustrated). This causes planetary gear 4 to rotate along the inner peripheral side of the internal gear. As described above, planetary gear 4 revolves around an axis of the sun gear between the sun gear and the internal gear.

The planetary transmission includes a rolling bearing device 10 that rotatably supports planetary gear 4. Rolling bearing device 10 includes a transmission shaft 1, a plurality of needle rollers 2, and a cage 3. Note that rolling bearing device 10 may include planetary gear 4.

A through hole is provided at a central portion of planetary gear 4. A wall surface 4b defining the through hole constitutes an inner peripheral surface of planetary gear 4. Transmission shaft 1 is inserted into the through hole of planetary gear 4. This causes planetary gear 4 to surround an outer periphery of transmission shaft 1. Transmission shaft 1 has, for example, a cylindrical shape. Transmission shaft 1 has an oil path 1a therein. Transmission shaft 1 corresponds to an inner member of rolling bearing device 10, and planetary gear 4 corresponds to an outer member of rolling bearing device 10. A needle roller bearing with a cage is disposed between an outer peripheral surface (raceway surface 1b) of transmission shaft 1 and an inner peripheral surface (raceway surface 4b) of planetary gear 4.

The needle roller bearing with a cage includes the plurality of needle rollers 2 and cage 3. Cage 3 has an annular shape and surrounds the outer peripheral surface of transmission shaft 1. Cage 3 has a plurality of pockets 3a. The plurality of pockets 3a are arranged at almost equal intervals along a circumferential direction. Each needle roller 2 is held by a corresponding one of the plurality of pockets 3a so as to be free to roll.

As illustrated in FIG. 2, each of the plurality of needle rollers 2 is disposed so as to roll on the outer peripheral surface serving as raceway surface 1b of transmission shaft 1 and the inner peripheral surface serving as raceway surface 4b of planetary gear 4. Planetary gear 4 is supported by the needle roller bearing with a cage so as to be free to rotate relative to transmission shaft 1.

Note that although the gear-type transmission has been described as an example to which the transmission shaft is applied, the transmission shaft can also be applied to a transmission of any type such as a belt type, a toroidal type, or a hydraulic type.

### <Structure of Transmission Shaft 1>

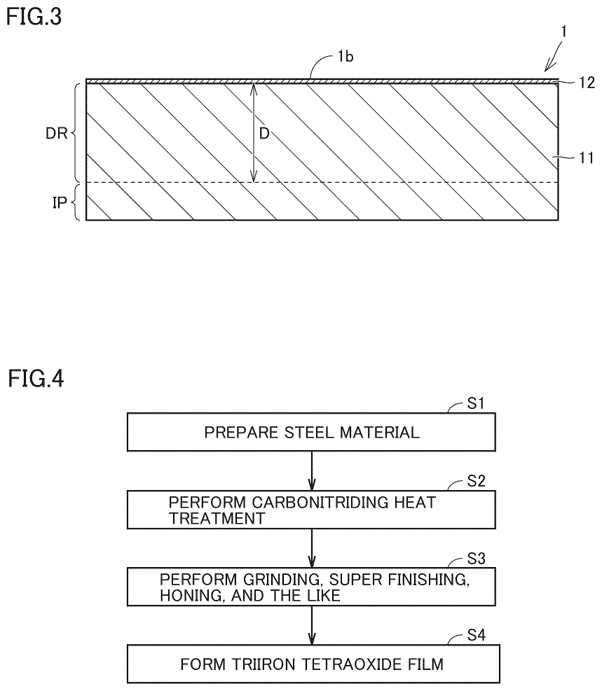

Next, the structure of transmission shaft 1 will be described with reference to FIG. 3.

FIG. 3 is an enlarged cross-sectional view of the structure of the transmission shaft in a region R illustrated in FIG. 2. As illustrated in FIG. 3, transmission shaft 1 includes a base material 11 and a triiron tetraoxide film 12. Base material 11 includes, for example, a steel material containing chromium. The material of base material 11 is, for example, any one of chromium steel, chromium-molybdenum steel, or nickel-chromium-molybdenum steel. The chromium steel, the chromium-molybdenum steel, and the nickel-chromium-molybdenum steel described above belong to SCr steel, SCM steel, and SNCM steel defined in Japanese Industrial Standards (JIS G 4053:2016), respectively.

Base material 11 is subjected to carbonitriding heat treatment. Therefore, base material 11 has a diffusion layer DR on its surface (outer peripheral surface). Diffusion layer DR is a part that is higher in nitrogen and carbon concentrations than the inside of the steel material constituting transmission shaft 1 (internal portion IP of diffusion layer DR). Diffusion layer DR has a depth D of, for example, greater than or equal to 0.6 mm and less than or equal to 1.5 mm.

Diffusion layer DR has a plurality of compound grains. The compound grains are crystal grains of at least one of iron (Fe) carbide, iron nitride, or iron carbonitride. More specifically, the compound grains are crystal grains of a compound obtained by replacing a part of iron site of cementite (Fe₃C) with chromium and replacing a part of carbon (C) site with nitrogen (N) (that is, the compound represented by (Fe, Cr)₃(C, N)).

Triiron tetraoxide film 12 is disposed in contact with the surface of base material 11. Triiron tetraoxide film 12 includes triiron tetraoxide (Fe₃O₄), so-called black rust, and is a passive oxide film. Triiron tetraoxide film 12 has a porous surface. Triiron tetraoxide film 12 has a thickness of greater than or equal to 1 μm and less than or equal to 2 μm. Triiron tetraoxide film 12 is disposed on at least raceway surface 1b of transmission shaft 1. Triiron tetraoxide film 12 may be disposed so as to cover all the surface of base material 11.

Triiron tetraoxide film 12 is formed on the surface of base material 11 by, for example, chemical conversion treatment called a blackening treatment method. The blackening treatment method in the present embodiment corresponds to immersion for at least 3 minutes in a strong alkaline solution primarily containing sodium hydroxide (NaOH) and having a temperature of greater than or equal to 130° C. and less than or equal to 160° C. Under this blackening treatment method, the temperature of the strong alkaline solution is as low as greater than or equal to 130° C. and less than or equal to 160° C., so that base material 11 is not heated to the extent that base material 11 deteriorates or deforms. Therefore, changes in structure, strength, properties, and the like of base material 11 are inhibited, and the structure, strength, properties, and the like of base material 11 obtained by the carbonitriding heat treatment are maintained even after the blackening treatment. Further, triiron tetraoxide film 12 formed by the blackening treatment method is as thin as greater than or equal to 1 μm and less than or equal to 2 μm. Therefore, the surface state of base material 11 in contact with triiron tetraoxide film 12 is almost the same as the surface state of a steel material subjected to the carbonitriding heat treatment.

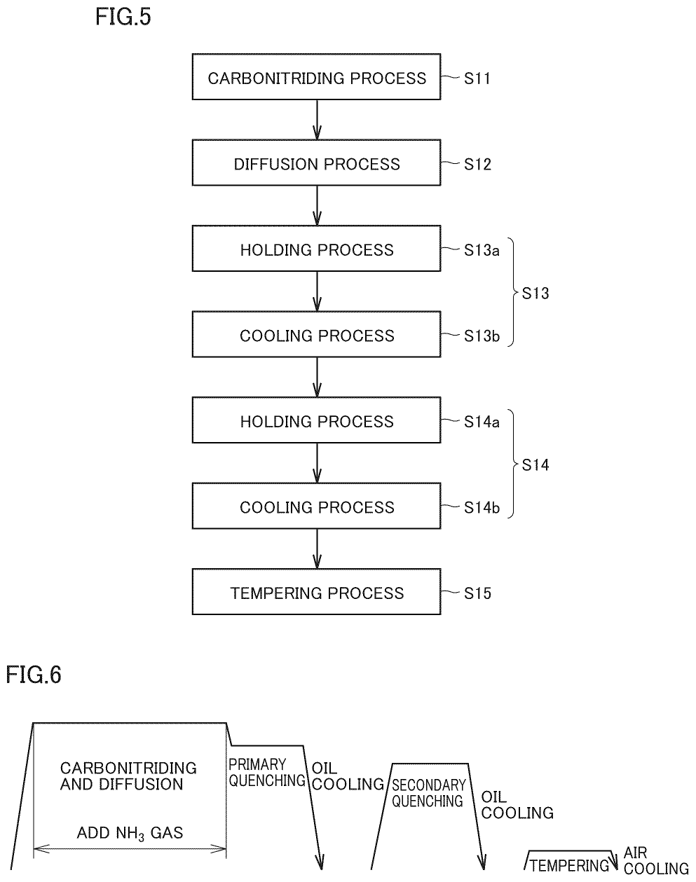

Base material 11 includes, for example, chromium molybdenum, and is preferably subjected to special carbonitriding heat treatment illustrated in FIG. 6 to be described later before the formation of triiron tetraoxide film 12. This special carbonitriding heat treatment makes the crystal grains of base material 11 finer and enriches a precipitation compound. As a result, surface damage resistance is enhanced, fatigue strength is improved, deformation due to deflection is inhibited, and the service life is further extended.

Base material 11 subjected to the special carbonitriding heat treatment will be described below.

Diffusion layer DR has a plurality of martensite blocks in addition to the plurality of compound grains. An average grain size of the compound grains in diffusion layer DR is less than or equal to 0.3 μm. The average grain size of the compound grains in diffusion layer DR is preferably less than or equal to 0.25 μm. A proportion of an area of the compound grains in diffusion layer DR is greater than or equal to 3%. The proportion of the area of the compound grains in diffusion layer DR is preferably greater than or equal to 8%. The proportion of the area of the compound grains in diffusion layer DR is, for example, less than or equal to 10%.

Note that the average grain size and the proportion of the area of the compound grains in diffusion layer DR are measured by the following method. First, a cross-section of diffusion layer DR is polished. Second, the polished surface is subjected to corrosion. Third, scanning electron microscopy (SEM) imaging is performed on the polished surface subjected to corrosion (hereinafter, an image obtained by SEM imaging is referred to as “SEM image”). Note that the SEM image is captured so as to contain a sufficient number (greater than or equal to 20) of compound grains. Fourth, image processing is performed on the obtained SEM image to obtain an area of each compound grain and a total area of the compound grains in the SEM image.

A relation of π×(equivalent circle diameter of compound grain)²/4=area of the compound grain is established between the equivalent circle diameter of the compound grain and the area of the compound grain. Therefore, the equivalent circle diameter of each compound grain appearing in the SEM image is obtained by calculating the square root of a value obtained by dividing the area of each compound grain appearing in the SEM image by 4/π. A value obtained by dividing the sum of the equivalent circle diameters of the compound grains appearing in the SEM image by the number of compound grains appearing in the SEM image is taken as the average grain size of the compound grains in diffusion layer DR. A value obtained by dividing the total area of the compound grains appearing in the SEM image by the area of the SEM image is taken as the proportion of the area of the compound grains in diffusion layer DR.

The martensite block is a block of a martensite phase including crystals having a uniform crystal orientation. The martensite phase is a non-equilibrium phase obtained by quenching an austenite phase of iron containing carbon in a solid state. In a case where a difference in crystal orientation between a block of a first martensite phase and a block of a second martensite phase adjacent to the block of the first martensite phase is greater than or equal to 15°, the block of the first martensite phase and the block of the second martensite phase are different martensite blocks. On the other hand, in a case where the difference in crystal orientation between the block of the first martensite phase and the block of the second martensite phase adjacent to the block of the first martensite phase is less than 15°, the block of the first martensite phase and the block of the second martensite phase constitute one martensite block.

The largest grain size of the martensite blocks in diffusion layer DR is less than or equal to 3.8 μm. The largest grain size of the martensite blocks in diffusion layer DR is, for example, greater than or equal to 3.6 μm.

Martensite blocks contained in diffusion layer DR having a crystal grain size of less than or equal to 1 μm constitute a first group. A ratio of an area of the martensite blocks constituting the first group to the total area of the martensite blocks contained in diffusion layer DR is preferably greater than or equal to 0.55 and less than or equal to 0.75.

The martensite blocks contained in diffusion layer DR may be divided into a second group and a third group. The largest crystal grain size of the martensite blocks belonging to the second group is less than the smallest crystal grain size of the martensite blocks belonging to the third group. A value obtained by dividing the total area of the martensite blocks belonging to the third group by the total area of the martensite blocks contained in diffusion layer DR is greater than or equal to 0.5. A value obtained by dividing the total area of the martensite blocks belonging to the third group excluding the martensite block with the largest crystal grain size belonging to the third group by the total area of the martensite blocks contained in diffusion layer DR is less than 0.5.

From another point of view, the martensite blocks belonging to the second group and the martensite blocks belonging to the third group are distinguished from each other by the following method. That is, first, martensite blocks are assigned to the first group sequentially from the martensite block with the smallest crystal grain size, and the total area of the martensite blocks assigned to the second group with respect to the total area of the martensite blocks is sequentially calculated. Second, the assignment of the martensite blocks to the second group is terminated when the proportion of the total area of the martensite blocks assigned to the second group to the total area of the martensite blocks reaches a limit of less than or equal to 50%. Third, martensite blocks not assigned to the second group are assigned to the third group.

The average grain size of the martensite blocks belonging to the third group is preferably greater than or equal to 0.7 μm and less than or equal to 1.4 μm. The average aspect ratio of the martensite blocks belonging to the third group is preferably greater than or equal to 2.5 and less than or equal to 2.8.

The martensite blocks contained in diffusion layer DR may be divided into a fourth group and a fifth group. The largest crystal grain size of the martensite blocks belonging to the fourth group is smaller than the smallest crystal grain size of the martensite blocks belonging to the fifth group. A value obtained by dividing the total area of the martensite blocks belonging to the fifth group by the total area of the martensite blocks contained in diffusion layer DR is greater than or equal to 0.7. A value obtained by dividing the total area of the martensite blocks belonging to the fifth group excluding the martensite block with the largest crystal grain size belonging to the fifth group by the total area of the martensite blocks contained in diffusion layer DR is less than 0.7.

From another point of view, the martensite blocks belonging to the fourth group and the martensite blocks belonging to the fifth group are distinguished from each other by the following method. That is, first, martensite blocks are assigned to the fourth group sequentially from the martensite block with the smallest crystal grain size, and the total area of the martensite blocks assigned to the fourth group with respect to the total area of the martensite blocks is sequentially calculated. Second, the assignment of the martensite blocks to the fourth group is terminated when the proportion of the total area of the martensite blocks assigned to the fourth group to the total area of the martensite blocks reaches a limit of less than or equal to 30%. Third, martensite blocks not assigned to the fourth group are assigned to the fifth group.

The average grain size of the martensite blocks belonging to the fifth group is preferably greater than or equal to 0.7 μm and less than or equal to 1.1 μm. The average aspect ratio of the martensite blocks belonging to the fifth group is preferably greater than or equal to 2.4 and less than or equal to 2.6.

The crystal grain size of the martensite blocks and the aspect ratio of the martensite blocks in diffusion layer DR are measured using an electron backscattered diffraction (EBSD) method.

First, a cross-sectional image (hereinafter, referred to as “EBSD image”) of diffusion layer DR is captured on the basis of the EBSD method. Note that the EBSD image is captured so as to contain a sufficient number (20 or more) of martensite blocks. On the basis of the EBSD image, a difference in crystal orientation between blocks of the martensite phase adjacent to each other is determined. Accordingly, a boundary of each martensite block is determined. Second, the area and shape of each martensite block appearing in the EBSD image are obtained on the basis of the boundary of each martensite block thus determined.

More specifically, the equivalent circle diameter of each martensite block appearing in the EBSD image is obtained by calculating the square root of a value obtained by dividing the area of each martensite block appearing in the EBSD image by 4/π. Among the equivalent circle diameters of the martensite blocks appearing in the EBSD image, the largest diameter is taken as the largest grain size of the martensite blocks in diffusion layer DR.

On the basis of the equivalent circle diameter of each martensite block obtained as described above, the martensite blocks belonging to the first group are determined from among the martensite blocks appearing in the EBSD image. A value obtained by dividing the total area of the martensite blocks belonging to the first group among the martensite blocks appearing in the EBSD image by the total area of the martensite blocks appearing in the EBSD image corresponds to a value obtained by dividing the total area of the martensite blocks in diffusion layer DR belonging to the first group by the total area of the martensite blocks in diffusion layer DR.

On the basis of the equivalent circle diameter of each martensite block obtained as described above, the martensite blocks appearing in the EBSD image are classified into the second group and the third group (or into the fourth group and the fifth group). A value obtained by dividing the sum of the equivalent circle diameters of the martensite blocks appearing in the EBSD image classified into the third group (or the fifth group) by the number of martensite blocks appearing in the EBSD image classified into the third group (or the fifth group) is taken as the average grain size of the martensite blocks in diffusion layer DR belonging to the third group (or belonging to the fifth group).

From the shape of each martensite block appearing in the EBSD image, the shape of each martensite block appearing in the EBSD image is elliptically approximated by the least squares method. This elliptic approximation by the least squares method is performed in accordance with the method disclosed in S. Biggin and D. J. Dingley, Journal of Applied Crystallography, (1977) 10, 376-378. The aspect ratio of each martensite block appearing in the EBSD method image is obtained by dividing the dimension of the major axis of the elliptic shape by the dimension of the minor axis of the elliptic shape. A value obtained by dividing the sum of the aspect ratios of the martensite blocks appearing in the EBSD image classified into the third group (or the fifth group) by the number of martensite blocks appearing in the EBSD image classified into the third group (or the fifth group) is taken as the average aspect ratio of the martensite blocks in diffusion layer DR belonging to the third group (or belonging to the fifth group).

Diffusion layer DR contains a plurality of prior austenite grains. Note that the prior austenite grains correspond to regions defined by crystal grain boundaries (prior austenite grain boundaries) of austenite grains formed in holding processes S13a and S14a (FIG. 5) to be described later. The average grain size of the prior austenite grains is preferably less than or equal to 8 μm. The average grain size of the prior austenite grains is more preferably less than or equal to 6 μm.

Note that the average grain size of the prior austenite grains in diffusion layer DR is measured by the following method. First, a cross-section of diffusion layer DR is polished. Second, the polished surface is subjected to corrosion. Third, optical microscopy imaging is performed on the polished surface subjected to corrosion (hereinafter, an image obtained by optical microscopy imaging is referred to as “optical microscopy image”). Note that the optical microscopy image is captured so as to contain a sufficient number (greater than or equal to 20) of prior austenite grains. Fourth, image processing is performed on the obtained optical microscopy image to obtain the area of each prior austenite grain in the optical microscopy image.

The equivalent circle diameter of each prior austenite grain appearing in the optical microscopy image is obtained by calculating the square root of a value obtained by dividing the area of each prior austenite grain appearing in the optical microscopy image by 4/π. A value obtained by dividing the sum of the equivalent circle diameters of the prior austenite grains appearing in the optical microscopy image by the number of the prior austenite grains appearing in the optical microscopy image is taken as the average grain size of the prior austenite grains in diffusion layer DR.

The average carbon concentration in diffusion layer DR located between the surface (outer peripheral surface) of base material 11 and a depth position at a distance of 10 μm from the surface of base material 11 is preferably greater than or equal to 0.7 mass %. The average carbon concentration in diffusion layer DR located between the surface (outer peripheral surface) of base material 11 and the depth position at a distance of 10 μm from the surface of base material 11 is preferably less than or equal to 1.2 mass %.

The average nitrogen concentration in diffusion layer DR located between the surface (outer peripheral surface) of base material 11 and the depth position at a distance of 10 μm from the surface of base material 11 is preferably greater than or equal to 0.2 mass %. The average nitrogen concentration in diffusion layer DR located between the surface (outer peripheral surface) of base material 11 and the depth position at a distance of 10 μm from the surface of base material 11 is preferably less than or equal to 0.4 mass %.

The average carbon concentration and the average nitrogen concentration in diffusion layer DR located between the surface (outer peripheral surface) of base material 11 and the depth position at a distance of 10 μm from the surface of base material 11 are measured using an electron probe micro analyzer (EPMA).

### <Method for Manufacturing Transmission Shaft 1>

Next, a method for manufacturing transmission shaft 1 according to the embodiment will be described with reference to FIGS. 4 to 6.

FIG. 4 is a flowchart illustrating the method for manufacturing the transmission shaft according to the embodiment. FIG. 5 is a flowchart illustrating a detailed process of carbonitriding heat treatment illustrated in FIG. 4. FIG. 6 is a graph showing a heat pattern under the method for manufacturing the transmission shaft according to the embodiment.

As illustrated in FIG. 4, the method for manufacturing the transmission shaft according to the present embodiment includes a process S1 of preparing a steel material, a process S2 of performing carbonitriding heat treatment, a process S3 of performing grinding, super finishing, honing, and the like, and a process S4 of forming triiron tetraoxide film 12. In process S1, a steel material including any one of chromium steel, chromium-molybdenum steel, or nickel-chromium-molybdenum steel is prepared.

In process S2, the steel material prepared in process S1 is subjected to carbonitriding heat treatment. In this carbonitriding heat treatment, for example, an atmosphere gas containing ammonia (NH₃) gas is used. In process S3, grinding, super finishing, honing, and the like are performed on the steel material subjected to the carbonitriding heat treatment. As a result, the steel material is finished to have an outer diameter equal to the outer diameter of transmission shaft 1.

Subsequently, in process S4, triiron tetraoxide film 12 is formed on the surface of the steel material. Triiron tetraoxide film 12 is formed by, for example, chemical conversion treatment called a blackening treatment method. In the present embodiment, the steel material is immersed for at least 3 minutes in a strong alkaline solution primarily containing sodium hydroxide and having a temperature of greater than or equal to 130° C. and less than or equal to 160° C. As a result, as illustrated in FIG. 3, triiron tetraoxide film 12 is formed on the surface of base material 11, and transmission shaft 1 of the present embodiment is manufactured.

Note that as the carbonitriding heat treatment in process S2, the special carbonitriding heat treatment illustrated in FIGS. 5 and 6 may be performed. Hereinafter, this special carbonitriding heat treatment will be described.

As illustrated in FIG. 5, the special carbonitriding heat treatment includes a carbonitriding process S11, a diffusion process S12, a primary quenching process S13, a secondary quenching process S14, and a tempering process S15.

In carbonitriding process S11, for example, the surface of the steel material including chromium-molybdenum steel prepared in process S1 illustrated in FIG. 4 is subjected to carbonitriding. Carbonitriding process S11 is performed by holding the steel material in a furnace at a predetermined temperature (hereinafter, referred to as “first holding temperature”) for a predetermined time (hereinafter, referred to as “first holding time”). As the atmosphere in the furnace, for example, a gas containing an endothermic converted gas (R gas) and ammonia is used. The first holding temperature is, for example, greater than or equal to 930° C. and less than or equal to 940° C. The first holding time is, for example, greater than or equal to 10 hours and less than or equal to 15 hours.

In diffusion process S12, carbon and nitrogen introduced through the surface of the steel material in carbonitriding process S11 are diffused into the steel material. Diffusion process S12 is performed by holding the steel material in the furnace at a predetermined temperature (hereinafter, referred to as “second holding temperature”) for a predetermined time (hereinafter, referred to as “second holding time”). As the atmosphere in the furnace, for example, a gas containing an endothermic converted gas (R gas) and ammonia is used. The second holding temperature is, for example, greater than or equal to 930° C. and less than or equal to 940° C. The second holding time is, for example, greater than or equal to 5 hours and less than or equal to 10 hours.

In diffusion process S12, α defined by the following expressions (1) and (2) is adjusted to be less than in carbonitriding process S11. α is adjusted by adjusting the amount of carbon monoxide, the amount of carbon dioxide, and the amount of undecomposed ammonia in the atmosphere, as is apparent from the expressions (1) and (2). Note that the amount of undecomposed ammonia in the atmosphere is preferably greater than or equal to 0.1 vol %.

$$\begin{matrix}[ Math 1 ] & \\ {a}_{c}^{*} = \frac{{( P c o )}^{2}}{K \times {Pco}_{2}} & ( 1 )\end{matrix}$$

Pco: Partial pressure of carbon monoxide (atm), Pco₂: Partial pressure of carbon dioxide (atm)
K: Equilibrium constant of K:<C>+CO₂⇔2CO

$$α = \frac{{P}_{{NH}_{3}}}{0.006 \times {( {P}_{H} )}^{\frac{3}{2}}} \times \frac{( 1.877 - 1.0 \; 55 \times ( {a}_{c}^{*} )}{100} \qquad ( 2 )$$

In primary quenching process S13, the steel material is quenched. Primary quenching process S13 includes holding process S13a and a cooling process S13b. Holding process S13a is performed by holding the steel material in the furnace at a predetermined temperature (hereinafter, referred to as “third holding temperature”) for a predetermined time (hereinafter referred to as “third holding time”). Note that, in primary quenching process S13, ammonia is not contained in the atmosphere in the furnace. The third holding temperature is greater than or equal to the A1 transformation point of the steel constituting the steel material and is less than the first holding temperature and the second holding temperature. The third holding temperature is, for example, greater than or equal to 850° C. and less than 930° C. The third holding temperature is preferably greater than or equal to 860° C. and less than or equal to 880° C. The third holding time is, for example, greater than or equal to 0.5 hours and less than or equal to 2 hours. In cooling process S13b, the steel material is cooled from the third holding temperature to a temperature less than or equal to the Ms point. Cooling process S13b is performed by, for example, oil cooling.

In secondary quenching process S14, the steel material is quenched. Secondary quenching process S14 includes holding process S14a and a cooling process S14b. Holding process S14a is performed by holding the steel material in the furnace at a predetermined temperature (hereinafter, referred to as “fourth holding temperature”) for a predetermined time (hereinafter referred to as “fourth holding time”). Note that, in secondary quenching process S14, ammonia is not contained in the atmosphere in the furnace. The fourth holding temperature is greater than or equal to the A1 transformation point of the steel constituting the steel material and less than the third holding temperature. The fourth holding temperature is, for example, greater than or equal to the A1 transformation point of the steel constituting the steel material and less than or equal to 850° C. The fourth holding temperature is preferably greater than or equal to 820° C. and less than or equal to 840° C. The fourth holding time is, for example, greater than or equal to 1 hour and less than or equal to 2 hours. In cooling process S14b, the steel material is cooled from the fourth holding temperature to a temperature less than or equal to the Ms point. Cooling process S14b is performed by, for example, oil cooling.

The compound grains in diffusion layer DR are precipitated mainly in holding process S13a and holding process S14a. The higher the holding temperature (the less the holding temperature), the higher the solid solubility limits of carbon and nitrogen in the steel. The third holding temperature is set higher than the holding temperature for normal quenching in order to avoid excessive precipitation of the compound grains in diffusion layer DR in holding process S13a (the solid solubility limits of carbon and nitrogen in the steel are set relatively higher than in normal quenching).

In holding process S14a, the compound grains are already precipitated in holding process S13a. That is, in holding process S14a, the carbon concentration and the nitrogen concentration in the base material are reduced, and the compound grains are relatively less prone to precipitation than in holding process S13a. Therefore, the fourth holding temperature is set lower than the third holding temperature in order to lower the solid solubility limits of nitrogen and carbon in the steel to promote the precipitation of the compound grains in holding process S14a. As a result, the proportion of the area of the compound grains in diffusion layer DR can be greater than or equal to 3%. Further, setting the fourth holding temperature lower than the third holding temperature makes it possible to inhibit coarsening of the compound grains precipitated in holding process S13a and holding process S14a, so that the average grain size of the compound grains in diffusion layer DR can be less than or equal to 0.3 μm.

In holding process S13a and holding process S14a, the growth of the austenite crystal grains is inhibited by the pinning effect of the compound grains precipitated in large amount and fine size as described above, and the austenite crystal grains remain fine. The martensitic transformation forms a plurality of martensite blocks in one austenite crystal grain. From another point of view, one martensite block is not formed across a plurality of austenite crystal grains. Therefore, the finer the austenite crystal grain, the finer the martensite block contained in the austenite crystal grain.

In tempering process S15, the steel material is tempered. Tempering process S15 is performed by holding the steel material in the furnace at a predetermined temperature (hereinafter, referred to as “fifth holding temperature”) for a predetermined time (hereinafter, referred to as “fifth holding time”) and then cooling the steel material. The fifth holding temperature is a temperature less than or equal to the A1 transformation point of the steel constituting the steel material. The fifth holding temperature is, for example, greater than or equal to 150° C. and less than or equal to 350° C. The fourth holding time is, for example, greater than or equal to 0.5 hours and less than or equal to 5 hours. The cooling in tempering process S15 is performed by, for example, air cooling.

The carbonitriding heat treatment illustrated in process S2 of FIG. 4 is performed in processes S11 to S15 described above.

FIG. 6 is a graph showing a heat pattern under the method for manufacturing the transmission shaft according to the embodiment. FIG. 6 schematically shows a relation between the first holding temperature to the fifth holding temperature and the first holding time to the fifth holding time.

### Action and Effect of Present Embodiment

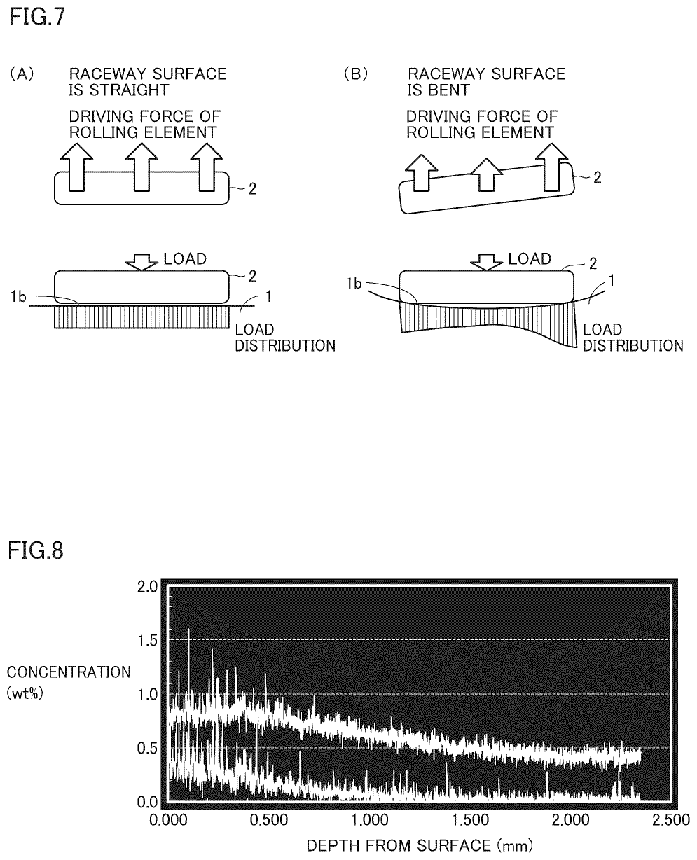

Next, actions and effects produced by the transmission shaft of the present embodiment will be described with reference to FIGS. 7(A) and 7(B).

FIG. 7 is a diagram illustrating a driving force of a needle roller and a load distribution applied to a raceway surface in each of a state (A) where the raceway surface is straight and a state (B) where the raceway surface is bent. As illustrated in FIG. 7(A), when raceway surface 1b is straight in an axial direction, a load distribution applied to raceway surface 1b through rollers (rolling elements) 2 is almost uniform. This also makes the driving force of rollers 2 almost uniform in the axial direction of rollers 2.

On the other hand, as illustrated in FIG. 7(B), a load is applied to roughly the center of transmission shaft 1 with both ends of transmission shaft 1 fixed. Therefore, transmission shaft 1 is used with raceway surface 1b bent in the axial direction and bending stress applied. In a case where raceway surface 1b is bent, skew is likely to occur due to a left-right difference in the shape of rollers 2 rolling on raceway surface 1b, and sliding increases accordingly. Therefore, oil film breakage is likely to occur, and the risk of surface damage due to metal contact increases.

Triiron tetraoxide film 12 has a porous surface and has a structure including indentations on the surface. Therefore, the formation of triiron tetraoxide film 12 allows oil to remain in the indentations on the surface to increase oil film forming ability and extend the service life under a lean lubrication condition.

Further, triiron tetraoxide film 12 is softer than the mating member (needle roller). This causes protrusions and indentations formed by machining marks or protrusions around indentations formed when foreign objects are caught to early wear, thereby allowing a reduction in metal contact during actual use. Note that, in a service life test, wear of about 0.8 μm occurred in triiron tetraoxide film 12 at the initial stage of operation, and the wear did not progress until breakage occurred. Triiron tetraoxide film 12 therefore needs to have a thickness of greater than or equal to be 0.8 μm (preferably greater than or equal to 1 μm). Further, in a case where triiron tetraoxide film 12 is made thicker, the time required for the blackening treatment increases, which leads to an increase in cost, so that triiron tetraoxide film 12 desirably has a thickness of less than or equal to 2 μm.

The blackening treatment allows a plurality of products to be treated at a time and can reduce an increase in cost due to additional treatment. Further, surface roughness is improved by the blackening treatment, so that it is possible to reduce machining man-hours required for transmission shaft 1.

Note that in a case where a unidirectional load is applied for a long time, there is a concern about minute plastic deformation (creep) that increases with time. In transmission shaft 1 subjected to the special carbonitriding heat treatment illustrated in FIGS. 5 and 6, however, yield stress on the surface layer portion on which the maximum bending stress is applied increases due to the refinement of the crystal grains and the increase of the precipitation compound. Therefore, creep deformation can be suppressed as compared with a general product subjected to carbonitriding treatment, and deformation due to long-time deflection can be minimized. Further, in the special carbonitriding heat treatment illustrated in FIGS. 5 and 6, the fatigue strength and the surface damage resistance performance of base material 11 are improved as compared with known carbonitriding treatment, and the service life is further extended.

### Example

Hereinafter, an experiment performed to confirm the effects produced by transmission shaft 1 according to the embodiment (hereinafter referred to as “this experiment”) will be described.

### <Sample>

In this experiment, sample 1 and sample 2 were used. A steel material used for sample 1 and sample 2 is SCM435 (JIS G 4053:2016) as shown in Table 1. Sample 1 and sample 2 are each a rotation shaft that is an inner member of a needle roller bearing device.

TABLE 1

| C | Si | Mn | P | S | Ni | Cr | Mo | Fe |
|---|---|---|---|---|---|---|---|---|
| (wt %) | (wt %) | (wt %) | (wt %) | (wt %) | (wt %) | (wt %) | (wt %) | (wt %) |
| 0.33- | 0.15- | 0.60- | Less than | Less than | Less than | 0.90- | 0.15- | Remainder |
| 0.38 | 0.35 | 0.90 | or equal to | or equal to | or equal to | 1.20 | 0.30 | |
| | | | 0.030 | 0.030 | 0.25 | | | |

As shown in Table 2, carbonitriding process S11 was performed on each of samples 1 and 2 under conditions that the first holding temperature is greater than or equal to 930° C. and less than or equal to 940° C., and the first holding time is 13 hours. Diffusion process S12 was performed on each of samples 1 and 2 under conditions that the second holding temperature is greater than or equal to 930° C. and less than or equal to 940° C., and the second holding time is 6 hours. Note that the amount of carbon monoxide, the amount of carbon dioxide, and the amount of ammonia in the atmosphere in carbonitriding process S11 and diffusion process S12 were set greater than or equal to 11 vol % and less than or equal to 17 vol %, greater than or equal to 0.05 vol % and less than or equal to 0.15 vol %, and greater than or equal to 0.1 vol % and less than or equal to 0.3 vol %, respectively.

Primary quenching process S13 was performed on each of samples 1 and 2 under conditions that the third holding temperature is 870° C., and the third holding time is 1 hour. Subsequently, secondary quenching process S14 was performed on sample 1 under conditions that the fourth holding temperature is 830° C., and the fourth holding temperature is 1.5 hours. Secondary quenching process S14 was not performed on sample 2. Subsequently, tempering process S15 was performed on each of samples 1 and 2 under conditions that the fifth holding temperature is 180° C., and the fifth holding time is 3 hours. Subsequently, mechanical polishing with a polishing amount of 150 μm was performed on each of samples 1 and 2 as machining process S3.

TABLE 2

| | Sample 1 | Sample 2 |
|---|---|---|
| First holding temperature (° C.) | 930-940 | 930-940 |
| First holding time (h) | 13 | 13 |
| Second holding temperature (° C.) | 930-940 | 930-940 |
| Second holding time (h) | 6 | 6 |
| Third holding temperature (° C.) | 870 | 870 |
| Third holding time (h) | 1 | 1 |
| Fourth holding temperature (° C.) | 830 | — |
| Fourth holding time (h) | 1.5 | — |
| Fifth holding temperature (° C.) | 180 | 180 |
| Fifth holding time (h) | 3 | 3 |

### <Measurement of Carbon Concentration and Nitrogen Concentration>

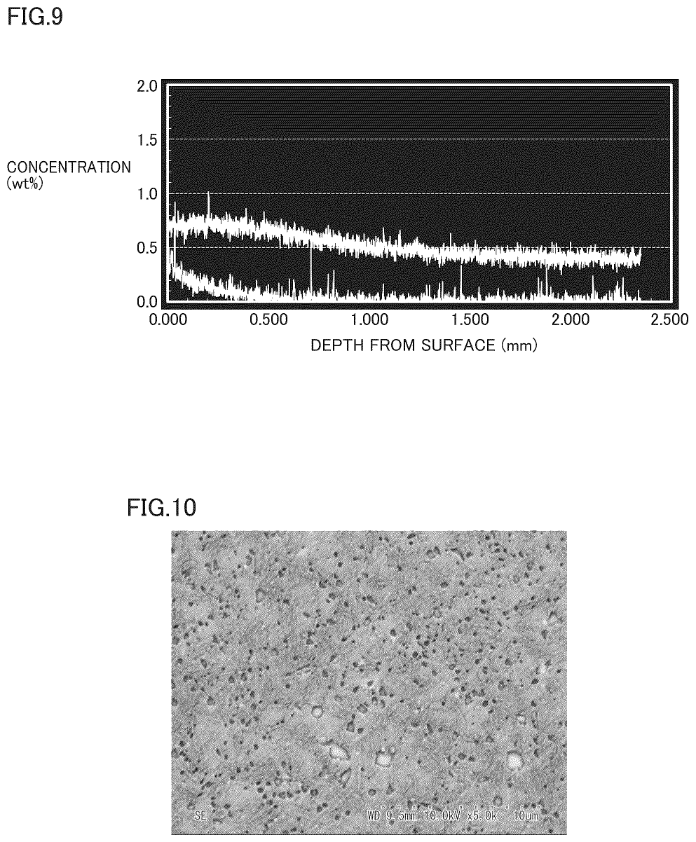

FIG. 8 is a graph showing a result of measuring the carbon concentration and the nitrogen concentration in sample 1 using the EPMA. FIG. 9 is a graph showing a result of measuring the carbon concentration and the nitrogen concentration in sample 2 using the EPMA. Note that, in FIGS. 8 and 9, the horizontal axis represents a distance (unit: mm) from the surface of sample 1 and sample 2, and the vertical axis represents the carbon concentration and the nitrogen concentration (unit: mass % concentration).

As shown in FIG. 8, many sharp peaks were observed in the carbon concentration and the nitrogen concentration in an area near the surface of sample 1. From this result, in sample 1, it was experimentally confirmed that fine compound grains such as carbide, nitride, and carbonitride are precipitated in the area near the surface. Further, in sample 1, the average carbon concentration in a region between the surface and the depth position at a distance of 10 μm from the surface was within a range of greater than or equal to 0.7% and less than or equal to 1.2%, and the average nitrogen concentration in the region was within a range of greater than or equal to 0.2 mass % and less than or equal to 0.4 mass %. On the other hand, as shown in FIG. 9, many sharp peaks were not observed in the carbon concentration and the nitrogen concentration in an area near the surface of sample 2. From this result, in sample 2, it was experimentally confirmed that fine compound grains such as carbide, nitride, and carbonitride are not precipitated in the area near the surface.

### <Observation of Structure>

FIG. 10 is an electron microscopy image of the area near the surface of sample 1. As shown in FIG. 10, it was confirmed that a large number of compound grains of greater than or equal to 0.2 μm and less than or equal to 3.0 μm are precipitated in the area near the surface of sample 1. It was further confirmed that the average grain size of the compound grains is about 0.25 μm in the area near the surface of sample 1. It was further confirmed that the proportion of the area of the compound grains is about 8% in the area near the surface of sample 1.

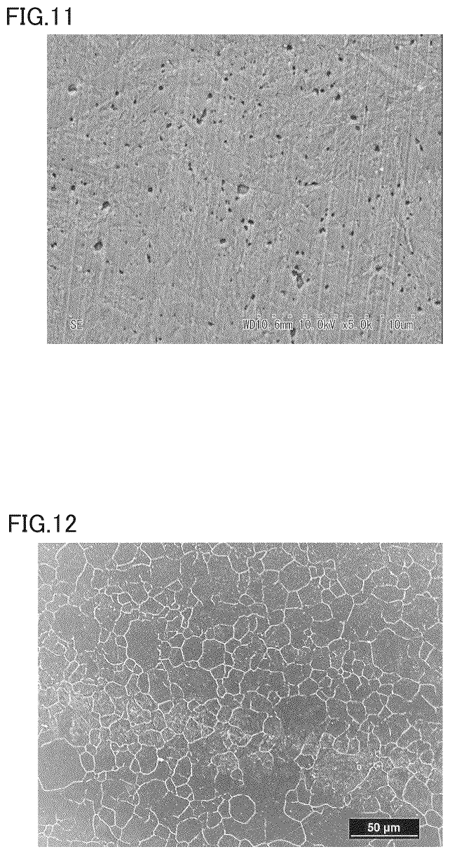

FIG. 11 is an electron microscopy image of the area near the surface of sample 2. As shown in FIG. 11, it was confirmed that the proportion of the area of the compound grains is about 1% in the area near the surface of sample 2.

Further, when the EBSD image of the area near the surface of sample 1 was checked, it was confirmed that the largest grain size of martensite blocks is within a range of greater than or equal to 3.6 μm and less than or equal to 3.8 μm in the area near the surface of sample 1. It was further confirmed that martensite blocks having a crystal grain size of less than or equal to 2 μm occupies 90% or more of the area of the martensite blocks in the area near the surface of sample 1. It was further confirmed martensite blocks having a crystal grain size of less than or equal to 1 μm occupies 55% or more and 75% or less of the area of the martensite blocks in the area near the surface of sample 1.

Further, when the EBSD image of the area near the surface of sample 2 was checked, it was confirmed that the largest grain size of martensite blocks is within a range of greater than or equal to 5.1 μm and less than or equal to 7.3 μm in the area near the surface of sample 2. It was further confirmed that martensite blocks having a crystal grain size of less than or equal to 2 μm occupies 65% or more and 80% or less of the area of the martensite blocks in the area near the surface of sample 2. It was further confirmed that martensite blocks having a crystal grain size of less than or equal to 1 μm occupies 35% or more and 45% or less of the area of the martensite blocks in the area near the surface of sample 2.

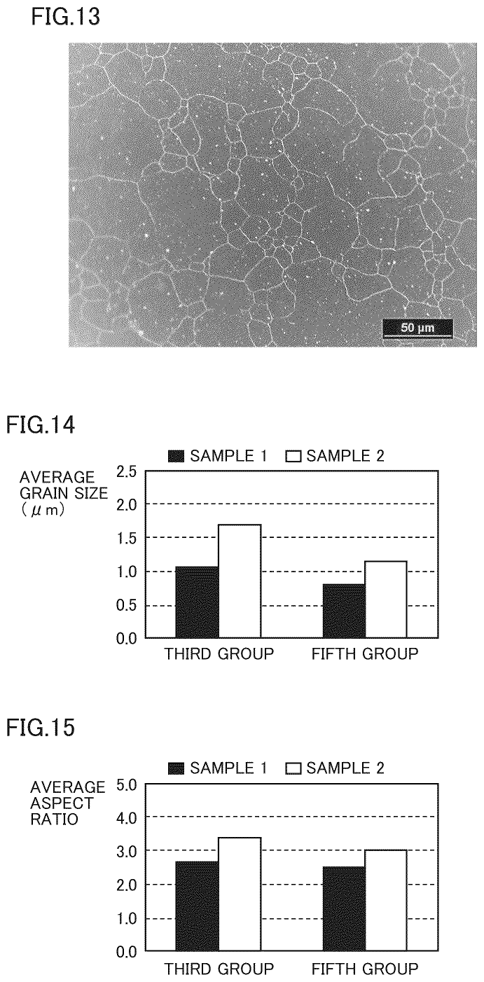

FIG. 12 is an optical microscopy image of the area near the surface of sample 1. As shown in FIG. 12, it was confirmed that, in the area near the surface of sample 1, the average grain size of prior austenite grains is within a range of greater than or equal to 4 μm and less than or equal to 8 μm, and the crystal grain size of the prior austenite grains is distributed in a range of greater than or equal to 1 μm and less than or equal to 10 μm. FIG. 13 is an optical microscopy image of the area near the surface of sample 2. As shown in FIG. 13, it was confirmed that, in the area near the surface of sample 2, the average grain size of prior austenite grains is within a range of greater than or equal to 12 μm and less than or equal to 25 μm, and the crystal grain size of the prior austenite grains is distributed in a wider range of greater than or equal to 5 μm and less than or equal to 100 μm.

FIG. 14 is a graph showing the average grain sizes of the martensite blocks belonging to the third group and the fifth group in the area near the surface of each of samples 1 and 2. Note that, in FIG. 14, the vertical axis represents the average grain size (unit: μm).

As shown in FIG. 14, the average grain size of the martensite blocks belonging to the third group was about 1.0 μm in the area near the surface of sample 1. It was therefore confirmed that, in sample 1, the average grain size of the martensite blocks belonging to the third group is within a range of greater than or equal to 0.7 μm and less than or equal to 1.4 μm.

As shown in FIG. 14, the average grain size of the martensite blocks belonging to the fifth group was about 0.8 μm in the area near the surface of sample 1. It was therefore confirmed that, in sample 1, the average grain size of the martensite blocks belonging to the fifth group is within a range of greater than or equal to 0.6 μm and less than or equal to 1.1 μm.

On the other hand, the average grain size of the martensite blocks belonging to the third group was about 1.7 μm in the area near the surface of sample 2. Further, the average grain size of the martensite blocks belonging to the fifth group was about 1.3 μm in the area near the surface of sample 2.

FIG. 15 is a graph showing the average aspect ratios of the martensite blocks belonging to the third group and the fifth group in the area near the surface of each of samples 1 and 2. Note that, in FIG. 15, the vertical axis represents the average aspect ratio.

As shown in FIG. 15, the average aspect ratio of the martensite blocks belonging to the third group was about 2.8 in the area near the surface of sample 1. It was therefore confirmed that, in sample 1, the average aspect ratio of the martensite blocks belonging to the third group is within a range of greater than or equal to 2.5 and less than or equal to 2.8.

As shown in FIG. 15, the average aspect ratio of the martensite blocks belonging to the fifth group was about 2.6 in the area near the surface of sample 1. It was therefore confirmed that, in sample 1, the average aspect ratio of the martensite blocks belonging to the fifth group is within a range of greater than or equal to 2.4 and less than or equal to 2.6.

On the other hand, the average aspect ratio of the martensite blocks belonging to the third group was about 3.2 in the area near the surface of sample 2. Further, the average aspect ratio of the martensite blocks belonging to the fifth group was about 3.0 in the area near the surface of sample 2.

<Rolling Contact Fatigue Service Life Test Under Lubrication with Foreign Object Trapped>

Using a transmission shaft, a needle roller bearing with a cage, and an outer member of each of samples 1 to 4, a rolling contact fatigue test under lubrication with foreign objects trapped (hereinafter, referred to as “rolling contact fatigue test”) was performed. Sample 3 is a transmission shaft obtained as a result of performing blackening treatment on sample 1, and sample 4 is a transmission shaft obtained as a result of performing blackening treatment on sample 2. The blackening treatment applied to each of samples 3 and 4 was performed by immersion for at least 10 minutes in a strong alkaline solution primarily containing sodium hydroxide and having a temperature of about 130° C. A triiron tetraoxide film formed by this blackening treatment had a thickness of 1.8 μm.

In the rolling contact fatigue test, the lubrication was oil bath lubrication using engine oil SAE30, the load was 24.5 kN, and the rotation speed of the outer member relative to the transmission shaft was 2150 rpm.

In the rolling contact fatigue test, evaluation was made on the basis of the L₁₀ life (a time from the start of the test to the occurrence of exfoliation is statistically analyzed to obtain a test time until a cumulative breakage probability reaches 10%) and the L₅₀ life (a time from the start of the test to the occurrence of exfoliation is statistically analyzed to obtain a test time until the cumulative breakage probability reaches 50%). The following Table 3 shows the results.

TABLE 3

| | Without blackening | With blackening |
|---|---|---|
| | treatment | treatment |
| General carbonitriding | — | ◯ |
| Carbonitriding heat treatment | ◯ | ⊙ |
| illustrated in FIGS. 5 and 6 | | |

◯: Increase in service life, ⊙: Significant increase in service life

From the results in Table 3, it was found that the service life of sample 4 subjected to the general carbonitriding and the blackening treatment increases relative to sample 2 subjected to the general carbonitriding but not subjected to the blackening treatment. Further, it was found that the service life of sample 3 subjected to the carbonitriding heat treatment illustrated in FIGS. 5 and 6 and the blackening treatment significantly increases relative to sample 2. Further, it was also found that the service life of sample 3 increases relative to sample 1 subjected to the carbonitriding heat treatment illustrated in FIGS. 5 and 6 but not subjected to the blackening treatment.

From the above, it was found that the service life increases in a case where the blackening treatment is performed as compared with a case where the blackening treatment is not performed. It was further found that the service life significantly increases in a case where the blackening treatment is performed after the special carbonitriding heat treatment illustrated in FIGS. 5 and 6 is performed.

It should be understood that the embodiment and example disclosed herein are illustrative in all respects and not restrictive. The scope of the present invention is defined by the claims rather than the above description, and the present invention is intended to include the claims, equivalents of the claims, and all modifications within the scope of claims.

### REFERENCE SIGNS LIST

1: transmission shaft, 1a: oil path, 1b, 4b: raceway surface, 2: needle roller, 3: cage, 3a: pocket, 4: planetary gear, 4a: teeth, 10: bearing device, 11: base material, 12: triiron tetraoxide film, DR: diffusion layer, IP: internal portion

1. A transmission shaft used in a transmission and having a raceway surface on which needle rollers roll, the transmission shaft comprising:
a base material including any one of chromium steel, chromium-molybdenum steel, or nickel-chromium-molybdenum steel and having, on a surface thereof, a diffusion layer including crystal grains of at least one of iron carbide, iron nitride, or iron carbonitride; and
a triiron tetraoxide film formed on the surface of the base material and disposed at least on the raceway surface.

2. The transmission shaft according to claim 1, wherein the triiron tetraoxide film has a thickness of greater than or equal to 1 μm and less than or equal to 2 μm.

3. The transmission shaft according to claim 1, wherein the base material includes chromium-molybdenum steel.

4. The transmission shaft according to claim 1, wherein an average grain size of prior austenite crystal grains in the surface of the base material is less than or equal to 8 μm.

5. The transmission shaft according to claim 1, wherein a proportion of an area of compound grains including the crystal grains of at least one of iron carbide, iron nitride, or iron carbonitride in the diffusion layer is greater than or equal to 3%, and an average grain size of the compound grains is less than or equal to 0.3 μm.

6. The transmission shaft according to claim 1, wherein the diffusion layer includes a plurality of martensite blocks.

7. The transmission shaft according to claim 6, wherein a largest grain size of the martensite blocks is less than or equal to 3.8 μm.

8. A bearing device comprising:
the transmission shaft according to claim 1; and
a plurality of needle rollers that roll on the raceway surface of the transmission shaft.
